(19) United States
(12) Patent Application Publication
(10) Pub. No.: US 2020/0016626 A1
(43) Pub. Date: Jan. 16, 2020

(54) Practical method and apparatus of plating substrates with carbon nanotubes (CNT)

(71) Applicant: Phillip T Holmes, Van Alstyne, TX (US)

(72) Inventor: Phillip T Holmes, Van Alstyne, TX (US)

(21) Appl. No.: 16/582,492

(22) Filed: Sep. 25, 2019

Related U.S. Application Data
(62) Division of application No. 14/967,837, filed on Dec. 14, 2015.

(51) Int. Cl. B05D 3/00

(52) U.S. Cl. CPC B05D 3/207

(57) ABSTRACT

A method for forming a CNT coating on a substrate, including the steps of: dispensing CNT particles to the substrate to form the CNT coating;
applying a magnetic field to the CNT coating; heating the CNT coating;
biasing the CNT particles to a first voltage and biasing the substrate to a second voltage.

### FIELD OF THE INVENTION

The invention relates to a coating-powder-supply apparatus and to a method of operating the coating-powder-supply apparatus, more particularly to CNT particles.

### BACKGROUND

In order to coat workpieces with coating powder, or powder for short, the powder is transported, with the aid of a powder-supply apparatus, to a powder spray gun and sprayed there onto the workpiece by means of the powder spray gun. The powder-coated workpiece is then heated, in which case the powder liquefies. Finally, the workpiece is cooled, and the powder hardens and forms a closed covering layer on the workpiece.

The powder-supply apparatus comprises a powder-storage container which serves for storing the coating powder. It additionally comprises a powder-conveying apparatus, by means of which the powder is extracted from the powder-storage container by suction and transported to the powder spray gun. The powder spray gun may be designed as a manual or automatic powder spray apparatus and has a spray nozzle or a rotary atomizer at its outlet, which is directed toward the workpiece.

The following documents are incorporated by reference in their entirety U.S. Pat. Nos. 4,440,106, 4,672,009, 5,495,094, 4,745,001, 3,239,465, 4,508,752, 5,248,864, 3,546,017, 6,270,853, 3,342,621, 1,465,818, 5,312,057, 1,488,541, 3,595,529, 8,121,456, 2,300,243, Re30727, 4,015,795, 5,289,845, 2,784,109, 5,034,243, 3,342,621, US patent application 20130141196 and US patent application 20150306181943.

### SUMMARY

An apparatus for forming a CNT coating on a substrate includes a CNT dispensing device to dispense CNT particles to the substrate to form the CNT coating; an electro magnet to apply a magnetic field to the CNT coating; and a heater to heat the CNT coating. The CNT particles may be biased to a first voltage and the substrate may be biased to a second voltage.

The first voltage may be an opposite polarity of the second voltage.

The apparatus may include a biasing device to bias the CNT particles.

The biasing device may include a voltage plate to bias the CNT particles.

The apparatus may include a resistance meter to measure the resistance of the CNT coating.

The flow of the CNT particles may be controlled by the resistance of the CNT coating.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a CNT system of the present invention;

FIG. 2 illustrates an additional embodiment of the electro magnet of the present invention;

FIG. 3 illustrates an additional embodiment of a permanent magnet of the present invention;

FIG. 4 illustrates a flowchart of the present invention.

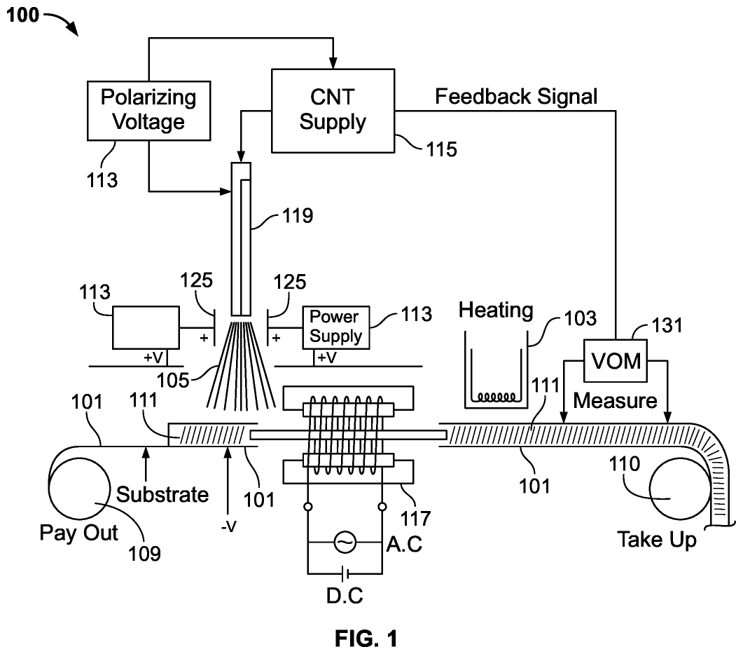

### DETAILED DESCRIPTION

100 CNT system
101 substrate
103 heater
105 particles
109 first winding roller
110 second winding roller
111 CNT coating/film
113 power source
115 CNT source
117 electro magnet
119 CNT dispensing device
121 bias device/electrostatic deflection device
123 power supply
125 plates
127 belt
131 resistance meter

The substrate 101 may be transported by a first winding roller 109 which may pay out the substrate 101 and a second winding roller 110 which may take up the substrate 101 and the CNT coating/film 111; more particularly, the first winding roller 109 may dispense the substrate 101 and the second winding roller 110 may collect the substrate 101 with the applied CNT coating/film 111. The first winding roller 109 and the second winding roller 111 may be controlled at a fixed or variable feed rate. The substrate 101 may be directed along a predetermined path by guides (not shown). The first winding roller 109 and the second winding roller 110 and guides may be biased by a positive charge from a voltage source (not shown) in order to provide a repelling force generated from the positively charged CNT particles 105 and the coating/film 111. The substrate 101 and the beam deflecting device 121 which may be beam deflecting plates may be negatively charged with respect to the positively charged CNT coating/film 111.

The substrate 101 may extend and move from the first winding roller 109 at a controlled predetermined speed such as feet/meters per minute and may be transported by rollers/guides (not shown) that may be isolated and insulated from ground by ceramic stand-offs, rubber/plastic contact surfaces or other appropriate devices.

The substrate 101 may enter a production environment where the CNT will be applied to the substrate 101 in the form of the CNT coating/film 111. The surfaces of the substrate 101 around CNT dispensing device 119 which may be a plating apparatus may be biased to an elevated voltage with respect to the CNT particles 105 being applied, to prevent the CNT particles 105 from being attracted to the walls or other surfaces in the vicinity of the CNT dispensing device 119.

The CNT particles 105 may be generated by the CNT dispensing device 119 which may be connected to a CNT source 115 and which may include a nozzle/manifold and may be controllably directed toward the substrate 101. Based on the size and shape of the substrate 101, the nozzles/manifolds may be adjusted to reflect the size and shape of the substrate 101, and the fluid pressure of the CNT particles 105 propelling the CNT particles 105 may be varied and controlled. The nozzle/manifold of the CNT dispensing device 119, and the CNT particles 105, may be positively charged with reference to the substrate 101. The process of the present invention may be a type of powder coating, and the positive atmosphere will carry the CNT particles 105 through the CNT system 100 and may propel the CNT particles 105 toward the substrate 101 as the CNT particles 105 leaves the nozzle/manifold of the CNT dispensing device 119.

As the CNT particles 105 leaves the nozzle/manifold of the CNT dispensing device 119, the CNT particles 105 may be agitated with several possible methods or devices, helping to provide an even coating of the coating/film 111. This agitation may be induced by the field generated by the electro magnet 117 or with ultrasonics, or AC magnetic fields, or some other appropriate method of causing the CNT coating/film 111 to be excited, to spin or repel each other CNT particle 105.

The CNT particles 105 attracted to the substrate 101 due to the voltage gradient generated by the controllable bias device/electrostatic deflection device 121 which may be an opposing pair of voltage plates which may be connected and controlled by a power supply 123. The power supply 123 may be computer-controlled (not shown) in order to vary the voltage and direction applied to the bias device/electrostatic deflection device 121. The bias device/electrostatic deflection device 121 controls the path of the CNT particles 105 as the CNT particles 105 exit the CNT source 115. As a consequence, the CNT particles 105 may be actively attracted to the substrate 101 as a result of the substrate 101 being an opposite charge as the CNT particles 105.

To further enhance the movement of the CNT particles 105 to the substrate, steering the particles 105 away from other surfaces, high voltage deflection plates 125 may be arrayed around the CNT source 115 supplying the CNT and conveying the substrate 101, which may be formed from aluminum or other appropriate material, which is efficient at carrying a charge, but less efficient at blocking/shielding magnetic fields. The beam deflecting plates 125 may be charged to very high voltages with reference to the positively charged CNT.

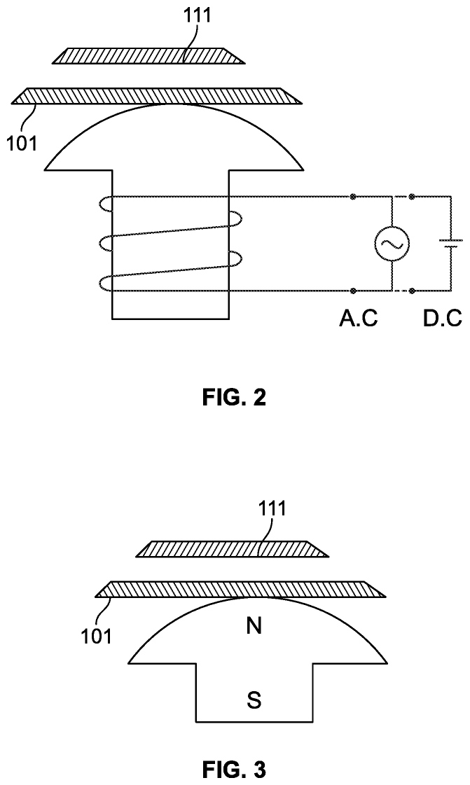

A magnetic field may be generated around the substrate 101 and the CNT coating/film 111, producing magnetic flux that may align the CNT coating/film 111. This magnetic field may be generated by an electro magnet 117 which may include a coil positioned in and around the substrate 101, or by a magnetic field generated in close proximity to the substrate 101 so that the CNT coating/film 111 will follow the lines of magnetic flux once they are attracted and deposited on the substrate 101. FIG. 2 illustrates an electro magnet being generated by the electrical force, and FIG. 3 illustrates a permanent magnet. If the magnetic flux is generated by a magnetic field suspended or positioned near the substrate 101, the lines of flux can be controlled by rotating the electromagnet/permanent magnet, producing axial or transverse alignment, or a combination of axial and transverse alignment. If an AC magnetic field is used to agitate the CNT coating/film 111, it may be desirable to overlap the AC and DC magnetic fields, so that the AC magnetic flux is applied first to the CNT coating/film 111, and subsequently the DC magnetic flux is applied to the CNT coating/film 111 as the substrate leaves the production apparatus.

Alternatively or in addition, a heater 103 may include an induction heater which may heat the CNT/substrate 101 by induction heating, creating eddy currents (also called Foucault currents), generated within a conductor, where resistance leads to Joule heating. However, the AC power used to generate the inductive heating could spin the CNT substrate 101. Superimposed magnetic fields could be generated and applied to the CNT substrate 101, one being a fixed magnetic field (DC), and another being a very high frequency AC field (producing the induction heating) which simultaneously may both align the CNT particles 105, and bond the CNT particles 105 to the substrate, effectively affixing the CNT to the substrate. Further, the present invention may employ DC induction heaters, pulsed DC induction heaters, and the AC induction heaters. Some predetermined frequencies with respect to the AC field may have little or no effect on the aligned plated CNT coating/film 111 due to a multitude of factors including the mass of the CNT (perhaps causing the CNT to vibrate, but not flip in the rapidly alternating magnetic field). This would be significantly affected by the mass of the CNT, especially if metal plated.

The present invention may include a plurality of combinations of AC and DC currents, biasing voltages (AC and DC), and the superposition of various fields. The above-mentioned fields and voltages may be affected by the type of the CNT particle 105, whether or not it is plated, the composition of the substrate 101, and/or the shape of the substrate 101. Some combination of the above mentioned electromagnetic forces may both or individually orient and affix the CNT particles 105 to the substrate 101, and may vary based on the many possible combinations of materials.

While induction heating may affix the CNT particles 105 to the substrate 101, other processes may be used, based on the above mentioned variations in materials, said materials possibly limiting the use of certain methods (heating, for instance could destroy a plastic substrate), to permanently affix, then encapsulate the CNT coating/film 111. The encapsulation may be formed by several methods, and includes acetylene torch, microwave heating, sputtering, hot dipping, molten metal, industrial lasers or other plating processes. Practically speaking, a fire scale occurs when metal is heated beyond a predetermined temperature. The present invention may employ a nitrogen rich atmosphere, the nitrogen preventing fire scale. A practical advantage is that heating some metals may relieve stresses that have built up from being handled. For example, a work hardened copper wire may be annealed when brought to a temperature high enough to melt the CNT coating/film 111 on the surface of the wire.

After finishing the affixing/heating/plating process or at any other time during the process, the quality and/or quantity of the CNT coating/film 111 may be measured by placing two electrodes at a predetermined distance apart and connected to the coating/film 111, then measuring the resistance between the two electrodes. This resistance may be determined on an intermittent basis, a periodic basis or may be continuously evaluated. The measured resistance may be compared to the expected resistance which may be found in a table or database. The difference may be used to increase or decrease the flow of CNT particles 105, or to adjust the production process (through feed rate, application of voltages and magnetic fields, and through varying the amount of CNT being deposited). If high frequency signals are used to measure resistance, it should not interfere with the manufacturing process.

The characteristics of the CNT coating/film 111 may be enhanced by applying a current through the substrate 101, while being simultaneously heated. This may encourage metals in the substrate 101 or the CNT coating/film 111 to better encapsulate the CNT coating/film 111, and reduce contact resistance between the CNT coating/film 111 and the substrate 101.

From there, the finished product can be treated like any other product, being wound on rolls, cut into plates, coated by extruder, painted, etc. Many finishes are possible.

The depth of CNT coating/film 111 can be controlled by the feed rate of the first winding roller 109 and the second winding roller 110 s and the volume of CNT particles 105 being supplied by the nozzle/manifold of the CNT source 115.

### CONCLUSION

This process can be made to run continuously, and scaled to fit various dimensions. The machinery used will be sourced from mature industries.

To speed development, analogous technologies include, wire recording, tape recording, induction heating, magnetism, powder coating, wire manufacturing, vacuum tubes, solid state lasers, air filtration systems, and so on. Various disciplines can be consulted to speed development of the process.

While other methods, such as mechanically applying CNT to a substrate, or wrapping CNT coated plastic ribbons/tapes around a traditional conductor, can work, they are difficult to terminate, are more fragile, and there is a strong potential for cross-contamination, whether from flaked tape, or shed CNT, which could cause a catastrophic failure (consider the effect of near superconducting dead shorts on the national grid). The process proposed here will orient the CNT, then encapsulate them, preventing shedding.

Possible beneficiaries, to name a few, would include aerospace, where all weight reduction is beneficial, high performance motors, EM pulse weapons, transformers, power transmission lines, power generation, arresting cables, shielding, and delicate measuring equipment that depend on low noise levels for accurate readings (resistance, AC or DC, always creates noise, as electricity is converted to heat, so that listening devices would exhibit better performance when using higher conductivity wiring).

The method for applying CNT is adaptable to existing processes, using mature technologies, and can be scaled.
The substrate 101 may be a solid and may be capable of carrying an electrostatic charge. The substrate 101 may be a conductor which may be plastic or metal but could be a semiconductor or insulator. Alternatively, a semiconductor or insulator substrate 101 may preprocessed by plating the semiconductor or insulator with an outer conductive layer to more readily accept the CNT coating or film 111. The substrate 101 may be cleaned and/or etched before exposure to the CNT particles 105. This cleaning process may be integrated into the CNT plating process. The substrate 101 may have paramagnetic or magnetic properties. The CNT particles 105 may have magnetic properties to aid in the manipulation of the particles 105 and provide a practical use in industry. However, unplated paramagnetic CNT particles 105 can also be manipulated by electrostatic and magnetic fields to achieve satisfactory results.
The temperatures withstood by CNT before decomposition may be in in excess of the heat generated in any of these processes (on the order of 6,000 degrees celsius).
Further, the present invention includes a production step that renders CNT coating/film 111 inert, having both sealed the CNT coating/film 111 to the substrate 101, and having encapsulated the CNT coating/film 111 with some other material, which may be a metal conductor. The encapsulation has the additional advantage of eliminating the potential of contamination of the environment of CNT.

The voltages involved range from negative DC, to several thousand volts positive DC, and possibly AC voltage used as a bias. However, the power supplies will have regulated current and voltage, adding a level of protection.

Voltages:

Like charges repel; opposite charges attract. Therefore, to prevent the CNT particles 105 from being attracted to the wrong target, voltage gradients will be used to steer the CNT particles 105. This requires numerous power supplies, and electrically isolated equipment.

The power source 113 which may be used to polarize the CNT particles 105, CNT coating/film 111, substrate 101, and manufacturing machinery may be connected to a resistance meter 131 which may be a volt ohm meter (VOM) to detect the changing current/voltage levels and to generate a feedback signal to the CNT source 115 to adjust the CNT particles 105 being dispensed, which may indicate changing levels of contamination or humidity as the current used to maintain the required polarization varies (higher levels of contaminants and humidity may increase the current required to maintain the desired voltage). Voltage source 118 may supply a polarizing voltage to the CNT source 115 and the CNT dispensing device 119 which may be a smaller magnitude than supplied to the plates 125. Therefore, part of the quality system is automated, alerting managers/workers if there is a variation in the production process and taking corrective action is required.

Because the voltages are relative to each other, and ground potential will be determined by the power supply grounds via the power chords or specialized ground wire, some equipment may be be electrically insulated, which may be achieved by ceramic, wood, rubber or any other material that isolates various voltages from each other. For instance, the pay-out and take-up formed by the first winding roller 109 and the second winding roller 110 may be isolated from high voltage sources for generating electrostatic fields (because the first winding roller 109 and the second winding roller 110 may be physically contacting the substrate 101, the substrate mechanism, the first and second winding roller 109, 110 may be at the same voltage potential or may be insulated from the substrate 101 isolated from ground potential (or earth) via insulators, or be grounded to earth, or connected to a negative voltage supply). Other equipment will be connected to various power supplies to introduce voltages to establish an electrostatic field. Equipment used for conveying materials, which may include rollers or guides, may be insulated from the substrate 101, since there function is for handling, not to apply electrical or magnetic forces.

It should be noted that current runs from negative to positive, which is counterintuitive. During development, it might be discovered that the voltages involved should be switched, with the substrate held at positive voltage, and CNT particles 105 and an at a relatively negative charge. The desired element is the production of a voltage gradient between substrate, CNT and the various apparatus used in the process.

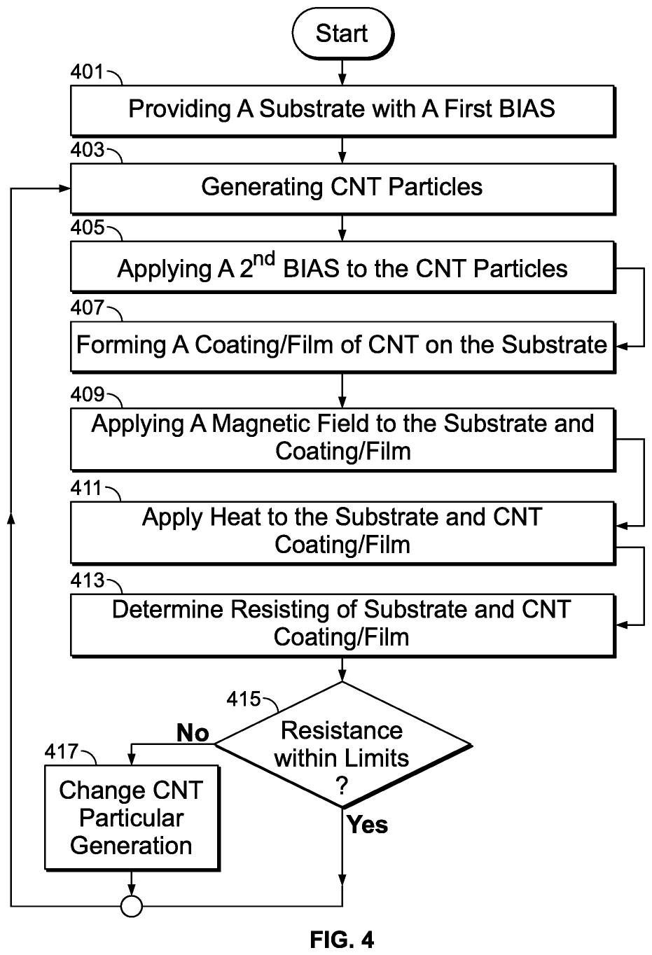

FIG. 4 illustrates a flowchart of the present invention and illustrates in step 401, providing a substrate with a first bias. In step 403, generating CNT particles, and in step 405, applying a second bias to the CNT particles. In step 407, the CNT particles form a coating/film on the substrate, and in step 409, and a magnetic field is applied to the substrate and the CNT coating/film. In step 411, heat is applied to the substrate and the CNT coating/film, and in step 413, the resistance of the substrate and the CNT coating/film is determined. In step 415, the resistance is evaluated to determine if it is within limits, if the resistance is within limits, control passes to step 403 and if the resistance is not within limits, control passes to step 417 were the particle generation is changed to correct the resistance.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A method for forming a CNT coating on a substrate, comprising the steps of:
dispensing CNT particles to the substrate to form the CNT coating;
applying a magnetic field to the CNT coating;
heating the CNT coating;
biasing the CNT particles to a first voltage and biasing the substrate to a second voltage.

2) A method for forming a CNT coating on a substrate as in claim 1, wherein the first voltage is an opposite polarity of the second voltage.

3) A method for forming a CNT coating on a substrate as in claim 2, wherein the biasing step is performed by a biasing device to bias the CNT particles.

4) A method for forming a CNT coating on a substrate as in claim 3, wherein the biasing device includes a voltage plate to bias the CNT particles.

5) A method for forming a CNT coating on a substrate as in claim 1, wherein the method includes the step of measuring the resistance of the CNT coating.

6) A method for forming a CNT coating on a substrate as in claim 5, wherein the method includes the step of controlling the flow of the CNT particles by the resistance of the CNT coating.
